(19) United States
(12) Patent Application Publication
(10) Pub. No.: US 2013/0304862 A1
(43) Pub. Date: Nov. 14, 2013

(54) SYSTEMS AND METHODS FOR DEVICE-AGNOSTIC WIRELESS SYNCHRONIZATION

(71) Applicants: Jon Lech Johansen, San Francisco, CA (US); Juan Soberanis, Sonoma, CA (US)

(72) Inventors: Jon Lech Johansen, San Francisco, CA (US); Juan Soberanis, Sonoma, CA (US)

(73) Assignee: doubleTwist Corporation, San Francisco, CA (US)

(21) Appl. No.: 13/983,302

(22) PCT Filed: Jan. 18, 2012
(86) PCT No.: PCT/US12/21635

§ 371 Date: Aug. 1, 2013

Related U.S. Application Data
(60) Provisional application No. 61/441,132, filed on Feb. 9, 2011.

(51) Int. Cl. H04W 56/00

(52) U.S. Cl. CPC H04W 56/001
USPC 709/217

(57) ABSTRACT

A method of synchronizing content between a mobile device and a computer, the mobile device having a client media file located thereon and the computer having a host media file located thereon. The method includes (A) the mobile device discovering a web service on the computer via a wireless connection with the computer; (B) the mobile device mounting the host media file from the computer; (C) the mobile device uploading a copy of the host media file to the mobile device; (D) the mobile device synchronizing the client media file with the uploaded copy of the host media file to form a revised host media file; and (E) the mobile device uploading the revised host media file to the computer; and (F) while the mobile device is performing steps (D) an (E), the mobile device monitoring the wireless connection between the mobile device and the computer.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to synchronizing, and, more particularly, to synchronizing data between mobile devices and computers.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a logical depiction of a device-agnostic wireless synchronization system;

FIG. 2 shows a typical computer or mobile device in the synchronization system;

FIGS. 3-5 are flowcharts of operation of aspects of the system of FIG. 1.

### SUMMARY

### Background and Overview

Mobile devices are ubiquitous. Many users have many devices from different manufacturers. Many mobile devices now include multiple functionalities (e.g., most mobile phones include a digital camera and can play music). Users may acquire content on their devices by downloading the content from other devices, including computers and other mobile devices. In some cases (e.g., where the device has a camera or a recorder or when the device is a computer), the content may be created on the mobile device itself. In addition to music and other content, many mobile devices include features for electronic mail (email), electronic calendars, and the like.

As used herein the term “content” refers to any kind of digital content or service, including, without limitation, any of the following (including combinations thereof): audio content (e.g., books, music, podcasts and the like), video content (e.g., movies, videos, and the like), and any other content that may be delivered to or from a mobile device (e.g., images, photographs, text, and the like), email, and calendars. The term “content,” as used herein, is not limited to the form or format of the content or what the content represent.

One problem with mobile devices is the potential for their content to get lost or to be inaccessible from other devices or locations. Another problem with mobile devices is that their content may become out of sync with the content on other devices or at other locations. For example, a user's mobile device may contain some of that user's music library, with the rest of the library being stored in one or more other places. That user may wish to synchronize her music library so that the mobile device includes the latest content from the user's computer music library.

As used herein, the term “content synchronization” refers to a process of making content at two locations substantially the same, subject to various criteria. It may be desirable to have the content at two locations be identical, or it may be desirable to apply certain criteria (e.g., user-defined and/or system-defined criteria) to content synchronization. The locations may be, for example, a mobile device and a computer. The criteria can provide filtering criteria and the like. For example, a user may want to synchronize all music purchased after a certain date (as opposed to just all music); or a user may wish to synchronize music but not video content. As another example, a user may wish to synchronize only some calendar information from a PDA to a computer.

Mobile device users face a number of problems with regard to content/device synchronization. Each device manufacturer stores its content in a proprietary format and each device manufacturer has its own proprietary synchronization protocols and tools/applications for mobile devices. This means that a user who has multiple devices from multiple manufacturers must use the different manufacturers' tools/applications to support content synchronization between and among such devices. Furthermore, in many cases a user may not be able to synchronize content from one manufacturer's device with that of another.

There have been some attempts to provide a device/platform independent synchronization standard. One such attempt is the Open Mobile Alliance (formerly known as SyncML (Synchronization Markup Language)). However, even if common synchronization protocols and formats are developed and shared among device manufacturers, there is still no way for a user who has multiple devices from multiple manufacturers to use a single application to synchronize a device across multiple platforms.

This invention provides, in some aspects, systems and methods for device-agnostic wireless synchronization.

This invention provides, in some aspects, a unifying media platform that connects consumers with all their media and all their devices, regardless of whether they are online or offline.

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

### DETAILED DESCRIPTION OF THE PRESENTLY PREFERRED EXEMPLARY EMBODIMENTS

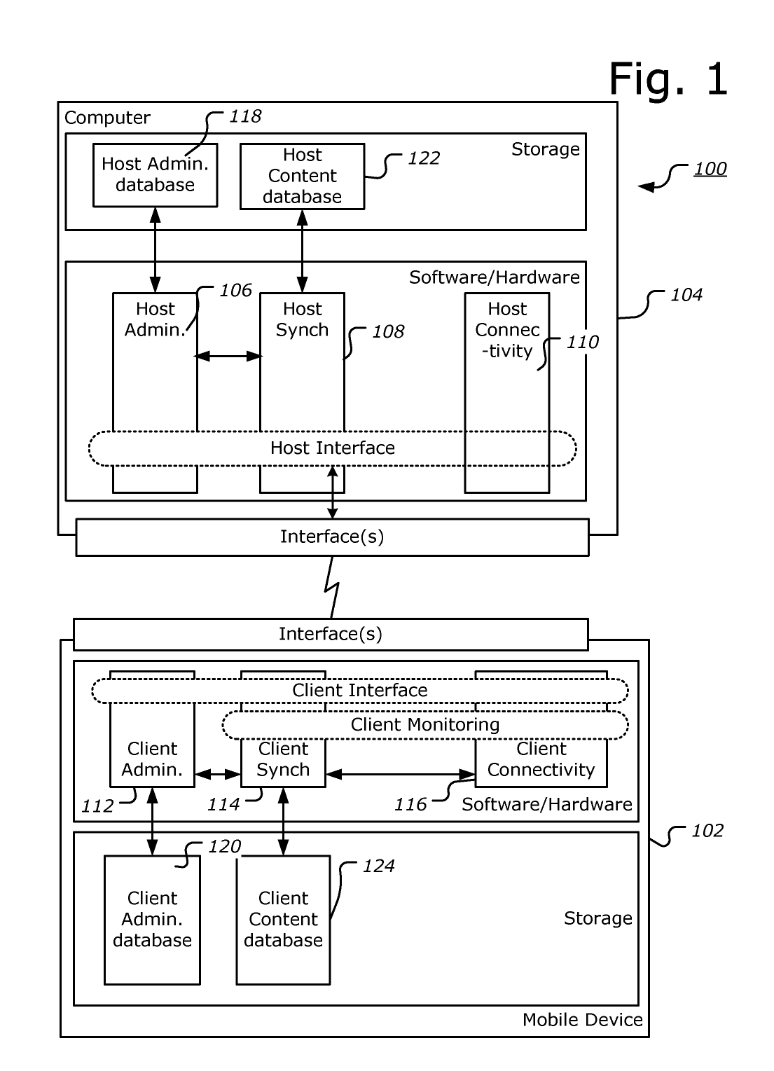

FIG. 1 shows logical depiction of a device-agnostic wireless synchronization system 100, in which an arbitrary mobile device 102 synchronizes data with an arbitrary computer 104. The mobile device 102 may be any mobile device, including, e.g., personal digital assistants (PDAs), music devices, mobile telephones, cameras, handheld and laptop computers, pagers, and the like. The mobile device may be, e.g., an Apple® mobile device such as an iPod or iPhone, an Android™ Smartphone, and the like. The computer 104 may be any type of computing device including a personal computer, a set-top box, a dedicated appliance or another mobile device.

One of ordinary skill in the art will readily appreciate and understand, upon reading this description, that the various processes described herein may be implemented by, e.g., appropriately programmed general purpose computers, special purpose computers and computing devices. In particular, the mobile device 102 and the computer 104 are computing devices.

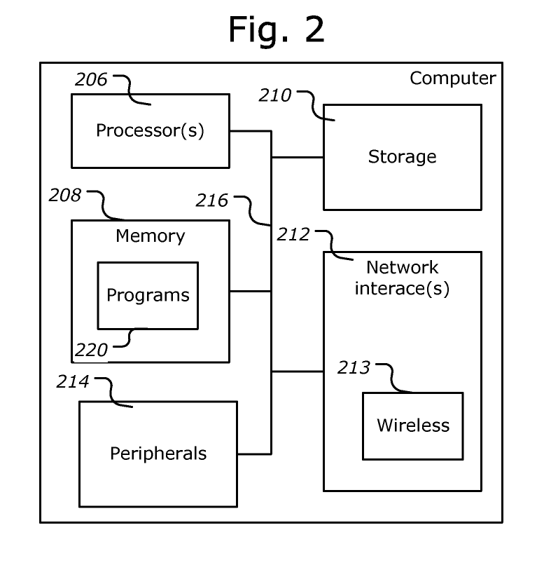

FIG. 2 illustrates a typical computing device (e.g., mobile device 102 or computer 104), including, typically, a processor 206, memory 208, storage 210, and a network interface 212.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

A computer system may also include various peripheral devices 214, including one or more input/output devices such as monitors, keyboards, mice, and any other desired devices.

Some computers may include a specialized input/output device (e.g., network interface 212) configured to connect to an external communication network and to external devices. The external communication network may include the Internet. The network interfaces 212 on the mobile device 102 and on the computer 104 include devices 213 (e.g., chips and the like) supporting wireless communication between the mobile device 102 and the computer 104. These devices may operate in any known way(s) number or mode(s) and using a number of different protocols such as Bluetooth®, ZigBee, Z-wave, 802.11, etc. Those of skill in the art will understand, upon reading this description, that the invention is not limited by the manner(s) or mode(s) or protocol(s) in which the devices and computers communicate.

The part of the synchronization system 100 operating on the mobile device 102 is generally referred to herein as the “client,” and the part of the synchronization system operating on the computer 104 is generally referred to as the “host.” The mobile device 102 includes mobile application software, operating on the device's hardware, for implementing the mobile device side (or client side) of the synchronization system 100. The computer 104 includes computer application software, operating on the computer's hardware, for implementing the computer side (or host side) of the synchronization system 100.

On the host (computer 104), the host application software includes host administrative software 106, host synchronization software 108, and host connectivity software 110, operating on the computer's hardware, to implement and control various aspects of the host-side of synchronization system 100. Similarly, on the client (mobile device 102), the client application software includes client administrative software 112, client synchronization software 114, and client connectivity software 116, operating on the mobile device's hardware, to implement and control various aspects of the client-side of the synchronization system 100.

The various programs described herein, including the host and client administrative software 106, 112, host and client synchronization software 108, 114, host and client connectivity software 110, 116, and host and client interface software will typically reside as programs 220 in the respective memory/memories 208 of the various computers/mobile devices.

In some implementations, a client/mobile device (or the user of a mobile device) may be registered with the host computer 104 or with a synchronization system 100 through some other means (not shown), and the host and client administrative software 106 and 112 controls such optional features such as user registration, payment, monitoring and the like. Those of skill in the art will realize and understand, upon reading this description, that the host and client administrative software 106 and 112 may interface with external systems (not show) to perform certain functions such as billing, registration, and the like, if needed. The host administrative software 106 may interface with a host administrative database 118 on the host computer 104 in order to perform its administrative functions. Similarly, client administrative software 112 on the client/mobile device 102 may interface with a client administrative database 120 on the client device 102 in order to perform its administrative functions. The administrative databases may include information relating to paired devices/computers, registration information and the like. Those of skill in the art will realize and understand, upon reading this description, that administrative databases may store required information in any appropriate form.

In presently preferred implementations, most web service methods exposed by a host require client authentication, e.g. in the form of a valid authentication token. In some implementations, in order to obtain an authentication token, the client must call the auth/login web service on the host and pass it a valid passcode. The passcode is a secret that is known only to the host and exposed to the user by some secure means. For example, in the case of a mobile phone as host, the client application might expose the passcode in a settings user interface (UI) that is viewable only by the owner of the phone. The client may persist an authentication token and re-use it on subsequent launches. This way, authentication need only take place once between a given host and client. Those of skill in the art will realize and understand, upon reading this description, that other forms of client/host authentication may be used.

The host/computer 104 includes a host content database 122 which stores content from various mobile devices associated (paired) with the computer. The host content database 122 on the host computer 104 may store the content for each mobile device in any appropriate form so that the content for each paired device associated with the computer can be accessed and synchronized with the corresponding device. Those of skill in the art will realize and understand, upon reading this description, that the host may access each client's content in the host content database in any known manner.

A host may be paired with multiple mobile devices of different types and from different manufacturers.

The client/mobile device 102 includes a client content database 124 which stores content associated with that device. The content may be stored in any manner that allows access by the client synchronization software 114 operating on the client device 102. Those of skill in the art will realize and understand, upon reading this description, that the client content database 124 on the client device 102 may be maintained in a proprietary manner (e.g., specific to the device manufacturer). The client synchronization software 114 should be able to read the content from the content database and write content to the client content database.

Host connectivity hardware and software 110 on the host computer 104 includes wireless interface 213 on the host computer and supports connection between the host computer 104 and wireless devices. Client connectivity hardware and software 116 on the client wireless device 102 includes wireless interface 213 on the mobile device 102 and supports connection between the client device 102 and host computer 104. In particular, both host and client connectivity software 110 and 116 support wireless connectivity between the host computer 104 and the mobile client device 102. As noted above, these devices may operate in any known way(s) number or mode(s) and using a number of different protocols such as Bluetooth®, ZigBee, Z-wave, 802.11, etc.

### Host Web Service & Commands

The host 104 provides a web service, and the client includes software that discovers, authenticates, and interacts with a host's web service and database.

Commands can be sent from the host 104 to the client 102 in the returned XML of the /ping web service. This enables the host to control the client without the need for the client to expose its own web service. Commands can be used for the host to inform the client of various things, e.g., the media database has been modified, the passcode has changed, the host name has changed, or that the sync process should be canceled.

A currently preferred implementation of the host web service provides/supports the following commands. Those of skill in the art will realize and understand, upon reading this description, that different commands may be used, and that the format and parameter names of the current commands may differ.

GET /ping

The GET /ping command is used by the calling party to verify device is still alive.

If the request is authenticated:

Cancels the reset timeout for the /sync/start command.

Returns XML with change times. The individual time elements are only included if they are relevant (i.e., if no cancel has happened during the active sync then CancelSyncTime is not included).

An exemplary XML ping response is shown in the following table:

<PingResponse>
<DatabaseUpdateTime>2010-10-09 17:07:57</DatabaseUpdateTime>
<PasscodeUpdateTime>2010-10-09 17:07:47</PasscodeUpdateTime>
<DeviceNameUpdateTime>2010-10-09 17:07:46
</DeviceNameUpdateTime>
<CancelSyncTime>2010-10-09 17:08:07</CancelSyncTime>
</PingResponse>

The GET /ping command always returns status code 200.

POST /auth/login?username=X&password=Y

This command is at the root and not under “Ifs”. In a current implementation username may be ignored. In this command, password is a base64 encoded SHA1 hash of the password.

Python example:

urllib.quote_plus(base64.b64encode(hashlib.sha1(‘12345’).digest( ))

If the password hash matches, this command will return a randomly generated token (128 bytes), otherwise it returns error code 403. The caller will need to pass the token in the request headers for every other command. If the token is not included, all the commands below will fail with error code 403.

The token should be cached. In some implementations the token may expire after a certain time period.

GET /auth/validate

This command returns status 200 if the request is authenticated (valid token is included in the header), otherwise, returns 403.

GET /device/properties

This command returns all device properties.

GET /device/getprop?name=X

This command returns the value for device property X, and may require authorization, depending on the property being requested. Properties may include: Device Name, Battery Level.

GET /sync/canSync?type=X

In this command, type is either “database”, “manual” or “auto”

This command returns status code 200 if synchronization can start, otherwise 403.

Database synchronization will be declined if device does not have backup capability and user is using the synchronization application (e.g., the device screen is on and the user is in the synchronization application)

In some implementations, auto synchronization may be declined if (a) the user is using the synchronization application, or (b) the device is playing media, or (c) the battery power is below 10%.

In some implementations, manual synchronization may be declined if battery power is below 10%.

Note: for the initial database retrieval when the device first appears, the client should simply proceed to get the database. If the device does not have backup capability (as indicated by the presence of the backup bitflag, FLAG_DATABASE_BACKUP_CAPABILITY=1, in the Flags property) then the database retrieval should be wrapped by sync start/stop.

Note regarding database updates: when a ping response indicates there's a database update in progress, the client should call canSync(“database”) and respect the result. If the device does not have backup capability then the database retrieval should be wrapped by sync start/stop.

GET /sync/start

The GET /sync/start command tells the application that synchronization is about to start. Users should be locked out of the various browse and playback screens once this command is sent. This command returns status code 200 if start was successful, otherwise 403 (i.e. client tried to start when canStart is false)

GET /sync/stop

The GET /sync/stop command tells the application that synchronization is done and the database can be mounted and playback can resume.

GET /fs/get?path=X

The GET /fs/get?path=X command returns the file with the appropriate content-type set in the headers. If file does not exist, returns error code 404. The parameter path is relative to an external storage path (e.g., an SD (Secure Digital) card). A current implementation uses the filename extension to generate the MIME type. Database calls may be added for more meta data.

Headers:

Content-Length: Size of the file

Content-Type: mime type for the file (generated using the filename extension).

PUT /fs/put?path=X

The PUT /fs/put?path=X command saves the data included with the request to path. In this command, path is relative to an external storage path (e.g., SD card). If the file already exists, this command returns error code 409.

GET /fs/list

The GET /fs/list command returns a list of folders and files (recursively). An exemplary format of the data is in the following table:

<dir>
<name><![CDATA[Podcasts]]></name>
<mod>1281616328000</mod>
<file>
<name><![CDATA[#201 planet money monopoly, a dangerous
game.mp3]]></name>
<size>8297704</size>
<mod>1282042630000</mod>
</file>
</dir>

GET /fs/rm?path=X

The GET /fs/rm?path=X command deletes the file at path. In this command, path is relative to an external storage path (e.g., SD card). If path does not exist or is not a file, returns error code 404.

GET /fs/rmdir?path=X

The GET /fs/rmdir?path=X command deletes the directory at path. In this command, path is relative to an external storage path (e.g., SD card). If path does not exist, this command returns error code 404. If path is not a directory, this command returns error code 403,

GET /fs/mkdir?path=X

The GET /fs/mkdir?path=X command creates the directory at path. In this command, path is relative to an external storage path (e.g., SD card). If path already exists, this command returns error code 409.

GET /fs/getprop?name=X

The GET /fs/getprop?name=X command returns the value for property X, requires auth depending on the property being requested. Properties may include: Total Capacity, Free Capacity, VolumeID. Some of these properties may require authorization.

Example: http://192.168.1.12:8008/fs/getprop?name=FreeCapacity

The System in Operation

In operation, the system 100 enables clients to synchronize content such as media, metadata, and playlists to a host over a wireless TCP/IP network. The host web service exposes means for discovery, authentication, remote file system access, sync locking, and out-of-band control signaling that enables commands to be sent between host and client. The host content database 122 contains a list of media on the host, metadata for the media, playlists, and podcast subscriptions and the like.

The operation of an exemplary embodiment of the system is described with reference to FIGS. 1-5.

Host Discovery

Before synchronizing can take place between a client 102 and a host 104, the client must discover the host.

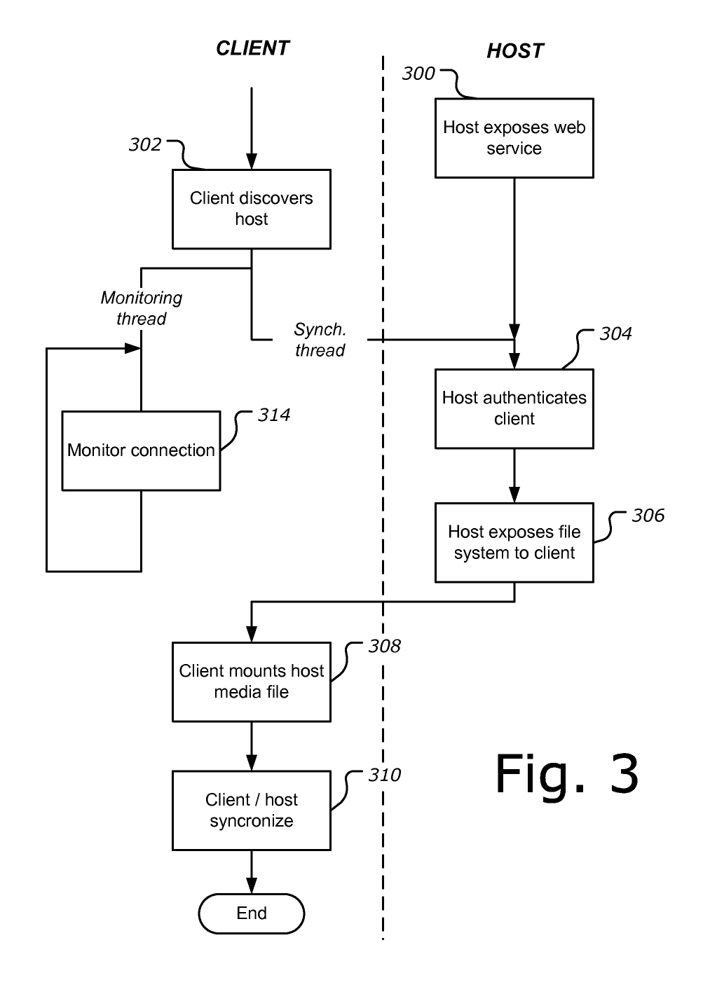

The host 104 creates a local network that exposes the host's web service (300 in FIG. 3). (In FIG. 3 the dashed line divides the activities of the client, on the left side of the drawing, and the host, on the right side of the drawing). The host exposing its web service (300), must take place before the client can discover that web service. However, there is no scale or timing in the flowchart of FIG. 3, so that the time at which the host exposes the web service may be any time before the client's discovery thereof.

The client 102 must first find the IP (Internet Protocol) addresses of hosts (at 302) on the local network that exposes the web service. In a presently preferred implementation, the web service must be on port 9968 for the scanning and manual discovery methods to work. Those of skill in the art will realize and understand, upon reading this description, that different discovery methods and different ports can be used. All discovery mechanisms store the IP address of the host to local storage upon successful connection so subsequent launches of the client can re-discover the host automatically.

In a presently preferred implementation the Bonjour protocol is used to enable host discovery without any interaction or configuration by the user/client. Hosts broadcast their services under a specific service name (e.g., “_dntp._tcp”). Note that “text records” in the bonjour service contain the same data as the device/properties web service.

The client connectivity software 116 includes a scanning mechanism/routine that polls the local network for appropriate synchronization hosts. Starting with the lowest subnet address and proceeding to the highest, an attempt to invoke the device/properties web service is made on each IP address. If the call returns successfully then a connection is made to that host. This process is optimized by creating a fixed number of threads that run the polling mechanism in parallel. A user of a client 102 may connect manually to a host by entering the IP address for the host directly into a modal dialog. The client attempts to invoke the device/properties web service on that IP address. If the call returns successfully then a connection is made to that host.

As noted above, most web service methods exposed by a host require a valid authentication token. To get an authentication token, the client must call the auth/login web service and pass it a valid passcode (at 304).

The host 104 must expose a file system that the client 102 will use to create folders and to put, get, and remove files (at 306). The host media/content database 122 should exist in a specific location in the file system before mounting can take place.

Once a host 104 has been authenticated, it is mounted by the client 102 (at 308). In a current implementation, the mounting process is as follows:
1. The fs/list web service is called to get a list of folders and files on the host.
2. The fs/getprop web service is called to get total and free storage space on the host.
3. The fs/get web service is called to get a particular database file from the host.

Once a host has been mounted, all of the client's content (media, metadata, playlists, and podcast subscriptions) on the host 104 is visible to the client 102.

Synchronization

Having connected to and authenticated with the host 104, and after mounting its content, the client 102 can synchronize with the host (at 310). The client 102 can insert media to the host and remove media from the host through a combination of web service calls and media database transactions. Synchronization between a client 102 and a host 104 essentially consists of moving content from the client to the host and/or moving content from the host to the client. The selection of which content is to be moved or copied to/from the client/host is made in any known manner.

In the presently preferred implementations, the host media/content file is first copied to the client. The client then makes changes to that file based on the current copy of the media/content file on the client, and then that updated media/content file is copied back to the host.

Media Insertion

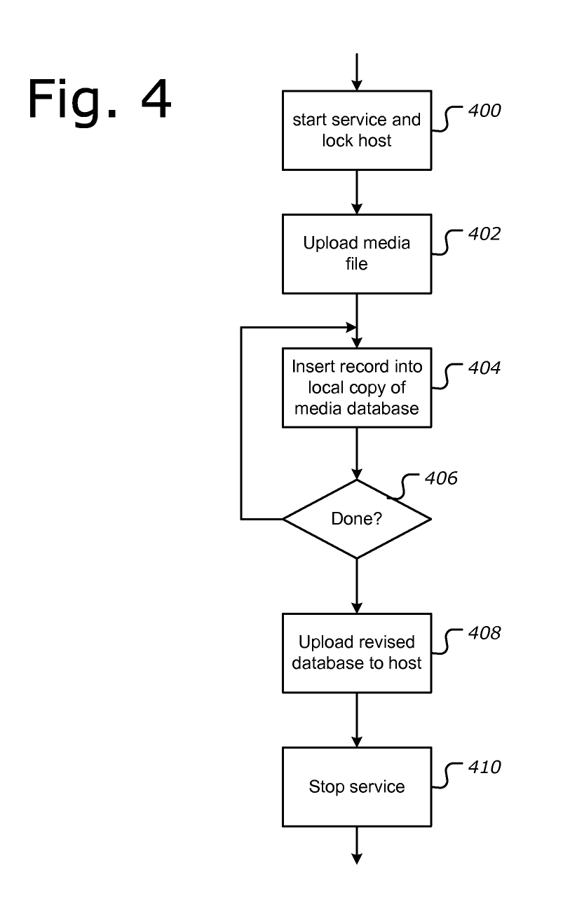

Copying content (media) from the client 102 to the host 104 consists of inserting media into the host. The process for client 102 to insert media into a host 104 is as follows (with reference to the flowchart in FIG. 4):
1. Call sync/start web service, which locks the host against changes to its database (at 400).
2. Call fs/put web service to upload media file (at 402)
3. Insert record into local copy of media database (at 404)
4. Goto step 2 until done (at 406)
5. Call fs/put web service to upload revised database to the host (at 408)
6. Call sync/stop web service (at 410).

Those of skill in the art will realize and understand, upon reading this description, that other methods of inserting media into the host may be used.

Media Removal

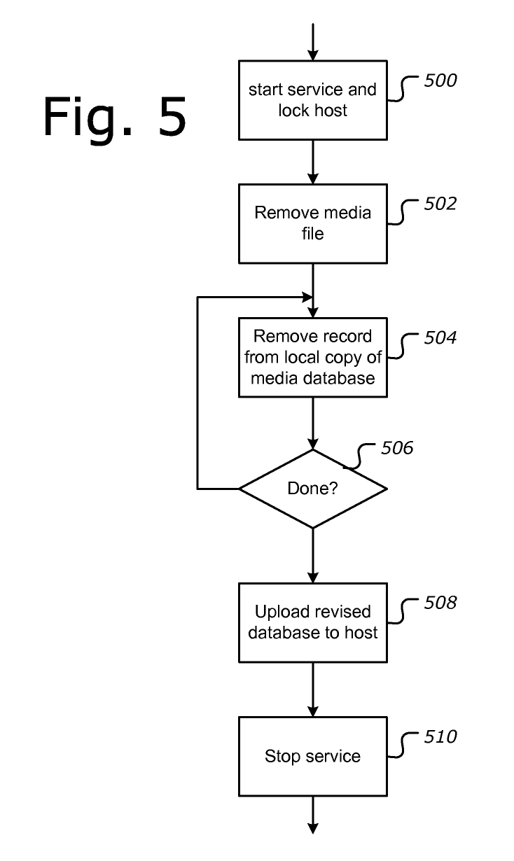

Deleting content (media) from the host 104 consists of removing the media from the host. The process for client 102 to remove media from the host 104 is as follows (with reference to the flowchart in FIG. 5):
1. Call sync/start web service, which locks the host against changes to its database (at 500).
2. Call fs/rm web service to remove the media file (at 502)
3. Remove record from local copy of media database (at 504)
4. Goto step 2 until done (at 506)
5. Call fs/put web service to upload revised database to the host (at 508)
6. Call sync/stop web service (at 510)

Those of skill in the art will realize and understand, upon reading this description, that other methods of removing media form a host may be used. Those of skill in the art will also realize and understand, upon reading this description, that some of the steps of media insertion and removal can be combined. For example, the first and last steps (locking the database and ending the web service are common to both processes, and so the insertions and deletions may be done with a single lock/end. In this case, the revised database will only need to be written once to the host.

### Control

### Connection Monitoring

Once a host 104 is connected to the client 102, a thread is created to monitor the presence of the host (at 314). The thread uses the /ping web service to determine if the host is still present. To deal with unreliable networks the process shown in the source code in the following table is used to increase tolerance of ping timeouts:

```
private void WaitForDeviceDeparture(DntpDevice device)
{
      bool isAlive = true;
      while (isAlive)
      {
            Thread.Sleep(pingSleepInterval);
            if (isAlive)
            {
                  int timeout = 2000;
                  PingResult response;
                  if (!TryPingDevice(device, timeout, out
response))
                  {
                        isAlive = false;
                        int numRetries = device.IsSyncing ? 15 :
3;
                        // Try a few more times in a row to
reduce flakiness.
                        for (int i = 0; i < numRetries &&
!isAlive; i++)
                        {
                              timeout += 2000;
                              isAlive = TryPingDevice(device,
timeout, out response);
                        }
                  }
                  if (isAlive)
                  {
                        try
                        {
      device.ProcessPingResponse(response);
                        }
                        catch (Exception ex)
                        {
                              ErrorLog.Default.WriteError(ex,
“”);
                        }
                  }
            }
      }
      RemoveDevice(device);
}
```

Those of skill in the art will realize and understand, upon reading this description, that other methods to increase tolerance of ping timeouts may be used.

Once a connection has timed out, the host 104 is removed from the client 102, but the connection monitoring thread remains active, looking for the return of the host. The process in the following table is less tolerant of web service timeouts so that it only re-connects with a host when it receives “strong signal”:

```
private void WaitForDeviceArrival(DiscoveredService
discoveredService)
{
      bool isDead = true;
      while (isDead)
      {
            Thread.Sleep(pingSleepInterval);
            if (TryPingService(discoveredService))
            {
                  isDead = false;
                  // Try a few more times in a row to reduce
flakiness.
                  for (int i = 0; i < 2 && !isDead; i++)
                        isDead =
!TryPingService(discoveredService);
            }
            // Refresh our service information.
            if (!isDead)
            {
                  try
                  {
                        discoveredService =
GetServiceInformation(discoveredService.IpAddress,
discoveredService.Port);
                  }
                  catch (Exception)
                  {
                        isDead = true;
                  }
            }
      }
      AddDevice(discoveredService);
}
```

Those of skill in the art will realize and understand, upon reading this description, that other reconnection methods may be used.

### Host Database

The host 104 must expose a file system that the client will use to create folders and to put, get, and remove files. The media database must exist in a specific location in the file system before mounting can take place.

In current implementations the host database includes a file (named MediaDatabase.sqlite3) which is a sqlite v3 database with the following schema: The database contains a record for every media file in the file system that is to be managed by the synchronization process/application. In a current implementation, playlists and podcast subscriptions are represented in the MediaCollections table.

CREATE TABLE Albums (_id integer, Name TEXT unique,
primary key (_id));
CREATE TABLE Artists (_id integer, Name TEXT unique,
primary key (_id));
CREATE TABLE Genres (_id integer, Name TEXT unique,
primary key (_id));
CREATE TABLE Media (_id integer, MediaId TEXT collate
nocase not null unique, Location TEXT collate nocase
not null unique, Signature TEXT, Type INTEGER, Kind
INTEGER, Size INTEGER, CreationDate DATETIME,
ModificationDate DATETIME, ImportDate DATETIME,
IsProtected INTEGER, ContainerFormat INTEGER, Title
TEXT, Artist TEXT, ArtistId INTEGER, Album TEXT,
AlbumId INTEGER, Genre TEXT, GenreId INTEGER,
PlayCount INTEGER, Rating INTEGER, LastPlayPosition
INTEGER, LastPlayDate DATETIME, ThumbnailId INTEGER,
Properties TEXT, ImageEncoding INTEGER, VideoEncoding
INTEGER, VideoDuration INTEGER, VideoAverageBitrate
INTEGER, TicksPerFrame INTEGER, Profile INTEGER, Level
INTEGER, HasAudio INTEGER, Width INTEGER, Height
INTEGER, PixelAspectRatio NUMERIC, DisplayAspectRatio
NUMERIC, AudioEncoding INTEGER, AudioDuration INTEGER,
Bitrate INTEGER, SampleRate INTEGER, SampleSize
INTEGER, Channels INTEGER, TrackNumber INTEGER,
AlbumTrackCount INTEGER, Duration INTEGER,
AverageBitrate INTEGER, Synopsis TEXT, PublicationDate
DATETIME, ThumbnailUrl TEXT, Author TEXT, ContentType
TEXT, SourceUri TEXT, primary key (_id));
CREATE TABLE MediaCollectionThumbnails (_id integer,
Location TEXT not null unique, primary key (_id));
CREATE TABLE MediaCollection_Media (_id integer,
MediaCollectionId INTEGER not null, MediaId INTEGER
not null, PlayOrder INTEGER not null, primary key
(_id));
CREATE TABLE MediaCollections (_id integer, Signature
TEXT not null unique, Location TEXT unique, Name TEXT,
ModificationDate DATETIME, ImportDate DATETIME,
MediaCollectionType INTEGER, ThumbnailId INTEGER,
Properties TEXT, Description TEXT, Homepage TEXT,
Author TEXT, Language TEXT, Url TEXT, LastUpdate
DATETIME, primary key (_id));
CREATE TABLE MediaThumbnails (_id integer, Location
TEXT not null unique, primary key (_id));
CREATE TABLE PropertyRecord (_id integer, Key TEXT
unique, Value TEXT, primary key (_id));
INSERT INTO PropertyRecord
VALUES(1,‘SchemaVersion’,1);
CREATE INDEX Location_idx on Media (Location);
CREATE INDEX MediaCollectionThumbnailLocation_idx on
MediaCollectionThumbnails (Location);
CREATE INDEX MediaId_idx on Media (MediaId);
CREATE INDEX MediaThumbnailLocation_idx on
MediaThumbnails (Location);

Although the above process has been described between a host computer 104 and a mobile device 102, it should be understood that both devices may be mobile devices or computers.

### Example

The synchronization system has been implemented for Microsoft Windows™ and the Apple® Macintosh operating systems and for Android™ players. Users are required to install or upgrade software on their Android™ phones to include the client-side functionality of the system. In some cases the host-side systems must also be upgraded. The WiFi option on the user's Android devices must be enabled to allow discovery. After the WiFi setting is enabled and the Android™ phone is connected to a host's network, a five digit password is used along with a device name to authenticate the device to the host. Once authenticated and paired, a sync can be initiated by the desktop client. When a sync is in process, a screen message will display when the user tries to access the Artists, Albums, Songs, Videos, Playlists or Podcasts categories on the Android™ phone.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

As used herein, the term “computer-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory 208, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art. The numerous formats, standards and protocols include Ethernet (or IEEE 802.3), SAP, ATP, Bluetooth®, and TCP/IP, TDMA, CDMA, and 3G; and/or (iv) encrypted to ensure privacy or prevent fraud in any of a variety of ways well known in the art.

A computer-readable medium can store (in any appropriate format) those program elements which are appropriate to perform the method.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of skill in the art will appreciate that the process may operate without any user intervention. In another embodiment, the process includes some human intervention (e.g., a step is performed by or with the assistance of a human).

While this invention has been described with respect to an online music subscription service, those skilled in the art will readily appreciate and understand, upon reading this description, that it is applicable to other services and to other forms of content, including digital content in any form and representing pictures, videos, movies, music, books. The invention is applicable to any service and to any content, regardless of its form or how the content is delivered.

When an ordinal number (such as “first”, “second”, “third” and so on) is used herein as an adjective before a term, that ordinal number is used (unless expressly specified otherwise) merely to indicate a particular feature, such as to distinguish that particular feature from another feature that is described by the same term or by a similar term. Thus, the mere usage of the ordinal numbers “first” and “second” before a term does not indicate any ordering or other relationship between the terms.

Thus is described a system for device-agnostic wireless synchronization. While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1. A method of synchronizing content between a mobile device and a computer, the mobile device having a client media file located thereon and the computer having a host media file located thereon, the method comprising:
(A) the mobile device discovering a web service on the computer via a wireless connection with the computer;
(B) the mobile device mounting the host media file from the computer;
(C) the mobile device uploading a copy of the host media file to the mobile device;
(D) the mobile device synchronizing the client media file with the uploaded copy of the host media file to form a revised host media file; and
(E) the mobile device uploading the revised host media file to the computer; and
(F) while the mobile device is performing steps (D) an (E), the mobile device monitoring the wireless connection between the mobile device and the computer.

2. The method of claim 1 wherein step (D) of synchronizing comprises:
inserting records from the client media file into the uploaded copy of the host media file.

3. The method of claim 1 wherein step (D) of synchronizing comprises:
deleting records from the client media file into the uploaded copy of the host media file.

4. The method of claim 1 further comprising:
locking the host media file prior to step (D).

5. The method of claim 1 wherein the mobile device is a device selected from the group: personal digital assistants (PDAs), music devices, mobile telephones, cameras, handheld computers; laptop computers, and pagers.

6. A mobile device comprising:
a processor; and
computer-readable storage comprising computer-readable program code, the computer-readable storage code being executable by the processor to perform a process of synchronizing content between the mobile device and a computer, the mobile device having a client media file located thereon and the computer having a host media file located thereon, wherein the process comprises:
(A) the mobile device discovering a web service on the computer via a wireless connection with the computer;
(B) the mobile device mounting the host media file from the computer;
(C) the mobile device uploading a copy of the host media file to the mobile device;
(D) the mobile device synchronizing the client media file with the uploaded copy of the host media file to form a revised host media file; and
(E) the mobile device uploading the revised host media file to the computer; and
(F) while the mobile device is performing steps (D) an (E), the mobile device monitoring the wireless connection between the mobile device and the computer.

7. The mobile device of claim 6 wherein act (D) of synchronizing comprises:
inserting records from the client media file into the uploaded copy of the host media file.

8. The mobile device of claim 6 wherein act (D) of synchronizing comprises:
deleting records from the client media file into the uploaded copy of the host media file.

9. The mobile device of claim 6 wherein the process further comprises:
locking the host media file prior to act (D).

10. The mobile device of claim 6 wherein the mobile device is a device selected from the group: personal digital assistants (PDAs), music devices, mobile telephones, cameras, handheld computers; laptop computers, and pagers.

11. A computer-readable storage medium comprising computer-readable program code, the computer-readable storage code being executable by a processor to perform a process of synchronizing content between a mobile device and a computer, the mobile device having a client media file located thereon and the computer having a host media file located thereon, wherein the process comprises:
(A) the mobile device discovering a web service on the computer via a wireless connection with the computer;
(B) the mobile device mounting the host media file from the computer;
(C) the mobile device uploading a copy of the host media file to the mobile device;
(D) the mobile device synchronizing the client media file with the uploaded copy of the host media file to form a revised host media file; and
(E) the mobile device uploading the revised host media file to the computer; and
(F) while the mobile device is performing steps (D) an (E), the mobile device monitoring the wireless connection between the mobile device and the computer.

12. The computer-readable storage medium of claim 11 wherein act (D) of synchronizing comprises:
inserting records from the client media file into the uploaded copy of the host media file.

13. The computer-readable storage medium of claim 11 wherein act (D) of synchronizing comprises:
deleting records from the client media file into the uploaded copy of the host media file.

14. The computer-readable storage medium of claim 11 wherein the process further comprises:
locking the host media file prior to act (D).

15. The computer-readable storage medium of claim 11 wherein the mobile device is a device selected from the group: personal digital assistants (PDAs), music devices, mobile telephones, cameras, handheld computers; laptop computers, and pagers.

16. The method of claim 2 wherein step (D) of synchronizing comprises:
deleting records from the client media file into the uploaded copy of the host media file.

17. The mobile device of claim 7 wherein act (D) of synchronizing comprises:
deleting records from the client media file into the uploaded copy of the host media file.

18. The computer-readable storage medium of claim 12 wherein the process further comprises:
locking the host media file prior to act (D).

19. The computer-readable storage medium of claim 12 wherein the mobile device is a device selected from the group: personal digital assistants (PDAs), music devices, mobile telephones, cameras, handheld computers; laptop computers, and pagers.

20. The computer-readable storage medium of claim 13 wherein the mobile device is a device selected from the group: personal digital assistants (PDAs), music devices, mobile telephones, cameras, handheld computers; laptop computers, and pagers.
